(19) United States
(12) Patent Application Publication
(10) Pub. No.: US 2023/0060822 A1
(43) Pub. Date: Mar. 2, 2023

(54) A METHOD FOR THE DIGESTION OF A URANIUM BASED MATERIAL

(71) Applicants: INSTITUT NATIONAL DES RADIOÉLÉMENTS, Fleurus (BE); CENTRE D'ETUDE DE L'ENERGIE NUCLÉAIRE, Bruxelles (BE)

(72) Inventors: Andrew Ken CEA, Landen (BE); Valery Claude Lino G. HOST, Fleurus (BE); Ann Josefine Georgette LEENAERS, Attenrode- Wever (BE); Christophe Etienne Michel WYLOCK, Fleurus (BE); Sven VAN DEN BERGHE, Verrebroek (BE); Thomas PARDOEN, Mont-Saint-Guibert (BE)

(21) Appl. No.: 17/760,312

(22) PCT Filed: Feb. 10, 2021
(86) PCT No.: PCT/EP2021/053238

§ 371 Date: Aug. 8, 2022

(30) Foreign Application Priority Data
Feb. 11, 2020 (EP) 20156652.8

(51) Int. Cl. G21G 1/00; G21F 9/30

(52) U.S. Cl. CPC G21G 1/001; G21F 9/30

(57) ABSTRACT

The present invention relates to a method for at least partially digesting a uranium (U)-based target material which comprises at least one uranium-metal (U-Me) alloy containing Mn, Fe, Co or Ni and comprising at least a U6Me phase. By means of an accelerant in a basic solution, the uranium in U-Me alloy oxidizes to U(VI). The accelerant comprises in particular KMnO4 whilst the U-Me alloy comprises a U—Mn alloy. The alloy preferably comprises two phases of an eutectic system, in particular the U6Mn/UMn2 system. The use of the accelerant enables an enhanced digestion of the U-Me alloy.

### FIELD OF THE INVENTION

The present invention relates to a method for at least partially digesting a uranium (U)-based material which comprises at least one uranium-metal (U-Me) alloy, wherein Me is selected from the group consisting of Mn, Fe, Co, Ni and combinations thereof and wherein the U-Me alloy comprises at least a U₆Me phase. The method is in particular used in the production of a medical radioisotope, in particular in the production of ⁹⁹Mo which further decays to ^{99m}Tc.

### BACKGROUND OF THE INVENTION

The use of radioactive isotopes is widespread, and includes applications in medicine, e.g. in diagnosis and treatments. These radioisotopes are produced primary by bombarding Highly Enriched Uranium (HEU) with neutrons, resulting in the fission of ²³⁵U and the production of daughter elements. However, while the demand for radioisotope continue to increase, the Energy Policy Act of 1992 required that foreign producers who received HEU from the United States cooperate in converting from HEU to Low Enriched Uranium (LEU) based production, as to reduce enrichment for civilian applications.

The decay product of ⁹⁹Mo to ^{99m}Tc (half-life=6 hours) is a foundation of diagnostic imaging for nuclear and internal medicine. It accounts for two thirds of all diagnostic imaging and is used for example in the detection of pathologies such as cancers, Alzheimer's disease and internal hemorrhaging.

A suitable method for the production of ⁹⁹Mo relies on the fission of ²³⁵U in research reactors, and involves the irradiation of ²³⁵U targets, its dissolution and subsequent recovery and purification. Known dissolution methods of such materials is based on acidic or basic dissolution, the latter being the most common due to the ease of recovery of other radioisotopes such as ¹³¹I and the absence of NOx gases, released during the acidic process.

R. Muenze et al. (R. Muenze et al, Science and Technology of Nuclear Installations, vol. 2013, article ID. 932546) have developed a standard method to produce ⁹⁹Mo from HEU/Al alloy clad. After irradiation of said clad with neutrons, the target is dissolved in a 3M NaOH/4M NaNO₃ basic solution. The dissolution allows a convenient separation of the materials in the mixture, by the dissolution of ⁹⁹Mo in the form of ⁹⁹MoO₄²⁻ ions, and the precipitation of aluminum oxide and Na₂U₂O₇ salts.

However, converting HEU to LEU targets poses the task to successfully adapt the method currently used in HEU to LEU materials. For example, the core of a fuel plate was a uranium-aluminum alloy (U—Al) containing 18 wt. % of highly enriched uranium (HEU) (>90 wt. % ²³⁵U) in Al. Upon using fuels containing low-enriched uranium (LEU) (<20 wt. % ²³⁵U), it was necessary to increase the amount of uranium in each fuel plate. This meant that for an U—Al alloy, the uranium concentration had to be increased to 45 wt. % to compensate the decrease in enrichment. Fuel plates containing U—Al alloy up to 30 wt. % of uranium were easily fabricated but difficulties arose in the fabrication of fuel plates with a U—Al alloy containing 45 wt. % of uranium, because of the fragility and tendency for segregation of this alloy. An alternative to overcome this problem was the use of dispersion fuels. In that case the core of the fuel plate is a dispersion of uranium compounds in aluminum and as such could incorporate larger quantities of low-enriched uranium. Thus, the lower content of ²³⁵U in LEU requires to use a larger amount of uranium-based materials to afford a desired amount of ⁹⁹Mo. This inevitably results in more radioactive waste. Furthermore, there is a need to avoid any major changes in the well-established production method and the equipment of ⁹⁹Mo production from HEU, to avoid additional processing cost.

Uranium aluminide-aluminum (UAlₓ/Al) dispersion fuels are used for the manufacturing of ⁹⁹Mo. The uranium aluminide is fabricated from a melting and casting operation and as a result usually contained a mixture of UAl₄, UAl₃ and UAl₂ (a typical composition is around 63% UAl₃, 31% UAl₄ and 6% UAl₂). Such a composition is referred to as UAlₓ. To produce a fuel plate, the UAlₓ fuel is ground and dispersed in a pure Al powder matrix. This mixture, commonly referred to as meat and forming the core of the fuel plate, is compacted and assembled in a frame that is placed between two cladding plates.

UAlₓ is a standard LEU material and the recovery of ⁹⁹Mo can be obtained by an basic and/or an acidic dissolution step on said irradiated LEU UAlₓ targets. The separated ⁹⁹Mo salt in the dissolution mixture is then recovered and purified by a series of processing steps.

As discussed above, one of the options to replace HEU by LEU fuels was to increase the amount of uranium in fuels. An alternative is to develop new fuels with high intrinsic U densities.

NL 2011311 B1 discloses a method of extracting radioactive ⁹⁹Mo from a low-enriched uranium target. This target comprises a uranium alloy with a relatively high uranium density such as UAlₓ, or even pure uranium metal. This uranium or uranium alloy is dispersed in an aluminum matrix. In order to be able to dissolve the target in the common basic solution the target is heated after irradiation under vacuum to a temperature of for example 700° C. to convert the uranium or uranium alloy into an uranium aluminide which is soluble in the basic solution. Such a process requires an extra process step which has to be carried out at a high temperature and under vacuum so that it complicates the entire process. Moreover, this extra process step requires time which reduces the useful lifetime of the ⁹⁹Mo (which has a half-life time of only 66 hours).

WO 2012/121466 A1 discloses a method of preparing medical radioactive ⁹⁹Mo by using a high-density low-enriched uranium target which consists of atomized metallic uranium particles which are compacted together with an Al—Si alloy powder. After irradiation, the irradiated target is treated first with a basic solution, which allows the aluminum cladding and the Al—Si matrix material to be dissolved. The uranium metal is then dissolved with a nitric acid solution. Two types of waste, one low-level nuclear waste and one intermediate nuclear waste resulting from respectively the basic and the acidic dissolution were therefore obtained. Intermediate-level nuclear waste requires specific nuclear waste disposal, such as solidification or landfill, and results in high disposal costs. A drawback of this method is that the basic and acidic nature of the two successive dissolution steps requires the dissolution to be done successively so that a large amount of radioactive liquid waste is generated including liquid radioactive waste that necessitates extensive nuclear waste disposal treatments.

High density U-based material targets, having an U-density above 6 gU/cm³, such as the uranium metal alloy U₆Mn, U₆Fe, U₆Co and U₆Ni, and U₃Si, U₃Si₂, U₃SiAl, etc. have gained attention as potential candidate to satisfy the high demand of ⁹⁹Mo. However, due to the high required purity levels of ⁹⁹Mo for medical application, the ease of processing, comprising the dissolution of the target, the extraction of ⁹⁹Mo and its purification, is also a crucial parameter to consider. Taking into account the intravenous use of medical radioisotope for nuclear diagnostic or therapy procedure, toxic components that may be produced and/or present in the materials should be avoided and/or easily removed. Moreover, the low burnup (i.e. the amount in percent of initial ²³⁵U fuel atoms that have undergone fission) irradiation conditions allows only a few percentage of the ²³⁵U to fission, hence requiring a relatively high uranium density in the target to make the process as efficient as possible and to reduce the resulting amount of radioactive unreacted waste which is currently not possible to recycle.

Despite the efforts have been directed to address the abovementioned challenges, there is still a need to provide an improved method of dissolving high density U-based materials, which allows an easy process, while limiting the amount of wastes, in particular radioactive wastes. An improved method of dissolving such materials would allow an efficient and medical-grade ⁹⁹Mo recovery, without the need to dramatically modify the current ⁹⁹Mo production apparatus for HEU targets.

### SUMMARY OF THE INVENTION

To be able to provide a high uranium density in the target, the uranium-based material used in the method of the present invention comprises a uranium metal alloy which comprises at least a U₆Me phase.

Although such U₆Me phase is described to be difficult to digest, in the same way as UAl₂ is known to be more difficult to digest than UAl₃ and UAl₄, the inventors have now surprisingly found that it is possible to provide an improved digestion method with such a material containing U₆Me fulfilling the above-mentioned needs.

Thus the present invention relates to a method for at least partially digesting a uranium-based material (U-based material, herein after) having a uranium density between 2 gU/cm³ and 19 gU/cm³ and comprising at least one uranium-metal alloy [U-Me alloy, herein after], wherein Me is selected from the group consisting of Mn, Fe, Co, Ni and combinations thereof and wherein the U-Me alloy comprises at least a U₆Me phase, which method comprises the following steps:
Step 1: providing the U-based material;
Step 2: contacting the U-based material with a basic solution thereby forming a mixture (1); and
Step 3: oxidizing at least part of said uranium in said mixture (1) to uranium (VI) by means of at least one accelerant selected from the group consisting of permanganate (MnO₄²⁻), chromate (CrO₄²⁻), dichromate (Cr₂O₇²⁻), perchlorate (ClO₄⁻), chlorate (ClO⁻), chlorite (ClO₂⁻), ozone (O₃) and hypohalite (XO⁻, in particular FO⁻, ClO⁻, BrO⁻, and IO⁻).

The U₆Me phase has a U density of about 17 gU/cm³ which is much higher than the commonly used UAlₓ materials having only a U density of between 6 and 8 gU/cm³ and therefore enables to still achieve a sufficiently high capacity with low enriched uranium (less than 20% ²³⁵U of the total amount of U) instead of with the conventional highly enriched uranium (more than 90% ²³⁵U). In accordance with the IRE process, the UAlₓ phases were dissolved with a basic solution containing NaOH and NaNO₃. A high ⁹⁹Mo yield was achieved due to the fact that apart from the oxidation of aluminum, uranium was oxidized to U(VI) by the presence of the NaNO₃. At the same time, no hydrogen gas was produced. In accordance with the present invention it has been found that this same process could be used for dissolving U₆Me phases. However, in contrast to UAlₓ phases, the NaNO₃ was not able to oxidize the uranium contained in the U₆Me phases to U(VI) but the inventors found this oxidation could be achieved by using one of the above identified accelerants for the oxidation of the U₆Me phases in the U-based material.

In a preferred embodiment of the method of the present invention, said at least one accelerant is added in a predetermined amount to said mixture, at least 50% of said predetermined amount, preferably at least 60% thereof, more preferably at least 70% thereof and most preferably at least 80% thereof being added to said mixture (1) after said basic solution has reacted for at least 30 minutes, preferably for at least 60 minutes, with said U-based material.

In this embodiment, the basic solution can first be used as such for oxidizing metals such as aluminum which are easy to oxidize so that a minimum of precipitated solids are produced whilst most of the accelerant is used in a next step to oxidize the uranium phases which are more difficult to oxidize. Since a smaller amount of accelerant is required in this way, less additional solid waste is produced. For example when permanganate is used as accelerant, no MnO₂ solid waste will be produced by reaction with aluminum, or by reaction with the hydrogen produced by aluminum in the basic solution, but only by reaction with uranium to produce U(VI).

According to certain embodiments of the method of the present invention, said U-based material comprises said U-Me alloy in a particulate form. Preferably, said U-Me alloy is dispersed in an aluminum based matrix, which aluminum based matrix comprises preferably at least 90.0 wt. %, more preferably at least 95.0 wt. % and most preferably at least 98.0 wt. % of aluminum.

When dispersed in an aluminum matrix, this matrix can easily be dissolved by means of the basic solution to release the particulate U-Me alloy particles. The present inventors have found that digestion of the U-Me alloy particles with the accelerant is slowed down or even stops when a layer of digestion products is formed on the surface of the particles.

In a particular embodiment of the method of the present invention the U-Me alloy is dispersed in said basic solution and the mixture (1) is subjected to ultrasonic waves, i.e. is ultrasonicated, during at least part of said oxidation Step 3.

By ultrasonication the layer of digestion products is removed from the surface of the particles to allow the digestion process to proceed.

In a preferred embodiment of the method of the present invention said particulate U-Me alloy has a D₉₀ value, measured in accordance with ASTM B214-16, which is smaller than 50 μm, preferably smaller than 40 μm, more preferably smaller than 30 μm and most preferably smaller than 25 μm.

The use of such small particles enable to digest them substantially completely without having to remove a layer of digestion products from the surface of the particles.

In a more preferred embodiment of the method of the present invention the at least one U-Me alloy comprises two phases of an eutectic system, a first of said phases being said U₆Me phase, and a second of said phases being a phase with a lower uranium density [lower U density phase, herein after], the at least one U-Me alloy comprising at least 5.0 wt. %, preferably at least 10.0 wt. %, more preferably at least 15.0 wt. % and most preferably at least 20.0 wt. % of said lower U density phase.

The lower U density phase is easier to digest by means of the accelerant in the basic solution. The basic solution and accelerant can penetrate via the parts of the lower U density phase that have already been digested into the particles. The particles of the U₆Me phase are formed by the grains thereof, which are much smaller than the particles of the U-Me alloy so that they can be digested completely without any sonication or without having to provide sufficiently small particles of the U-Me alloy itself.

In certain embodiments of the method according to the present invention, the particulate U-Me alloy has a D₁₀ value, measured in accordance with ASTM B214-16, which is larger than 1 μm, preferably larger than 2 μm, more preferably larger than 3 μm and most preferably larger than 4 μm.

### DETAILED DESCRIPTION

The present invention generally relates to a method for at least partially digesting a U-based material. This U-based material has in particular a U density between 2 gU/cm³ and 19 gU/cm³. The U density of the U-based material is preferably higher than 4 gU/cm³, more preferably higher than 5 gU/cm³ or more preferably higher than 6 gU/cm³, or higher than 7 gU/cm³ or higher than 8 gU/cm³ or higher than 9 gU/cm³. The uranium contained in the U-based material consists at least partially of ²³⁵U. The U-based material is thus a material which can be used as target to produce fission products of ²³⁵U, in particular ⁹⁹Mo. In practice, the U-based material is enclosed, as so-called meat, between an aluminum frame and aluminum cladding plates. The U-densities are thus the U-densities of this meat not taking into account the volume of any frame or cladding plates.

Suitable cladding material for use in the U-based materials according to the present invention, is not particularly limited, and any cladding material that is generally used in nuclear reactors may be used.

This being said, the cladding materials is advantageously aluminum or an aluminum alloy.

The uranium in the U-based material is preferably low enriched uranium (LEU), i.e. the uranium consists preferably for at most 20 wt. % of ²³⁵U. In practice, the U-based material will first be irradiated, in particular with neutrons, to fission at least part of the ²³⁵U, to produce in particular ⁹⁹Mo, which is then dissolved and extracted from the U-based material. In the present specification and claims, the U-based material is described as it is before being irradiated.

The uranium is contained in the U-based material in a U-Me alloy wherein Me is Mn, Fe, Co, Ni or a combination of two or more of these elements. The U-Me alloy may thus be a ternary alloy comprising uranium and two other metals. Examples of such a ternary alloy are U₆Fe_{0.6}Mn_{0.4} and U₆Ni_{0.6}Fe_{0.4}. The U-Me alloy is however preferably a binary alloy, i.e. a U-Me alloy wherein Me is selected from the group consisting of Mn, Fe, Co and Ni. The U-based material may comprise a mixture of such U-Me alloys but comprises preferably only one of these U-Me alloys. In the rest of the text, the expression “U-Me” is understood, for the purposes of the present invention, both in the plural and the singular, that is to say that the uranium-based material may comprise one or more than one U-Me alloy.

The U-Me alloy is preferably in a particulate form or consists in other words of particles. The particulate U-Me alloy is further preferably dispersed in an aluminum based matrix. This matrix may consist of pure aluminum or may comprise an aluminum alloy which comprises preferably at least 90.0 wt. %, more preferably at least 95.0 wt. % and most preferably at least 98.0 wt. % of aluminum. The aluminum alloy may comprise for example an Al—Si alloy containing for example 2 to 5 wt. % of Si. An aluminum or aluminum alloy matrix is advantageous since it enables to control the heat of the target during the irradiation and since it can be dissolved quite easily with a basic solution thus producing aluminum oxide and hydrogen gas. Production of hydrogen gas can be avoided by including for example nitrate in the basic solution which converts the hydrogen gas in ammonia that can be easily removed together with the produced Xe and Kr gasses (in accordance for example with the so-called Romol-99 process).

In order to achieve the above described U densities, the U-Me alloy comprises at least a U₆Me phase. As described hereabove, Me is preferably one of the metals Mn, Fe, Co or Ni. The U₆Me phase may however comprise a combination of these metals and may be indicated by the general formula U₆MnₓFe_{y}Co_{z}N_{1-x-y-z} phase, wherein x, y and z are each independently a number of from 0 to 1 and the sum of x, y and z is equal to or less than 1. According to the literature, the U densities of such a U₆Me phase are 17.7 gU/cm³ for U₆Fe, 17.6 gU/cm³ for U₆Ni, 17.7 gU/cm³ for U₆Co and 17.8 gU/cm³ for U₆Mn. In accordance with the method of the present invention, the U-based material is contacted with a basic solution thereby forming a mixture (1).

For the purpose of the present invention, the term “solution” refers to an aqueous solution, and the term “aqueous solution” refers to a solution in water, demineralized water, or any aqueous solution comprising mineral salts.

The basic solution is a solution comprising one or more alkali or alkaline earth hydroxides, preferably alkali hydroxides.

Preferably, the basic solution is a solution comprising one or more alkali hydroxide, wherein the alkali cation is chosen from the group consisting of Li⁺, Na⁺, K⁺ and Cs⁺. More preferably, the basic solution is a solution comprising sodium hydroxide.

Preferably, said one or more alkali or alkaline earth hydroxides in the basic solution are present in a concentration of at least 1.0 mol/L, more preferably at least 2.0 mol/L, or more preferably at least 3.0 mol/L.

It is further understood that the concentration of the one or more alkali or alkaline earth hydroxides are preferably equal to or less than 9.0 mol/L, more preferably equal to or less than 8.0 mol/L, or more preferably equal to or less than 7.0 mol/L.

Preferably the one or more alkali or alkaline earth hydroxides are present in the basic solution in a concentration between 2.0 mol/L-8.0 mol/L, more preferably in a concentration between 2.5 mol/L-7.0 mol/L.

When the U-based material further comprises aluminum, it is preferable that the basic solution in Step 2, as detailed above, further comprises at least a mineral salt.

Within the context of the present invention, any mineral salt capable of reacting with hydrogen (H₂) which can be generated by the reaction of aluminum with the one or more alkali or alkaline earth hydroxides, as detailed above, can be used. Typically, the mineral salt is an alkali nitrate wherein the alkali cation is chosen from the group consisting of Li⁺, Na⁺, K⁺ and Cs⁺, preferably, the mineral salt is sodium nitrate.

In general, the mineral salt is present in the basic solution in a concentration of at least 1.0 mol/L, more preferably at least 1.5 mol/L, or more preferably at least 2.0 mol/L.

It is further understood that the concentration of the mineral salt is preferably equal to or less than 6.0 mol/L, more preferably equal to or less than 5.0 mol/L, or more preferably equal to or less than 4.5 mol/L.

Preferably the mineral salt is present in the basic solution in a concentration between 2.0 mol/L and 5.0 mol/L, more preferably in a concentration between 2.5 mol/L and 4.5 mol/L.

Step 2 of the method according to the present invention is preferably carried out at a temperature at which the basic solution may already react with the U-based material, in particular with any aluminum contained therein. According to certain embodiments of the method of the present invention, Step 2 is carried out at a temperature higher than 10° C., preferably at a temperature higher than 20° C. more preferably at a temperature higher than 30° C., or higher than 40° C. or more preferably higher than 50° C. It is further understood that the temperature is preferably equal to or less than 500° C., more preferably equal to or less than 450° C., even more preferably equal to or less than 400° C. The vessel is preferably pressurized to enable to use of higher temperatures.

In step 3 of the method according to the present invention at least part of the uranium contained in mixture (1) is oxidized to uranium (VI) by means of at least one accelerant (i.e. oxidant) selected from the group consisting of permanganate (MnO₄²⁻), chromate (CrO₄²⁻), dichromate (Cr₂O₇²⁻), perchlorate (ClO₄⁻), chlorate (ClO₃⁻), chlorite (ClO₂⁻), ozone (O₃) and hypohalite (XO⁻). The accelerant can be added in the form of a salt, in particular in the form of a sodium or potassium salt.

The accelerant preferably comprises permanganate, which is preferably added in the form of a salt, in particular in the form of sodium or potassium permanganate. Preferably, the U-Me alloy is a U—Mn alloy so that the use of permanganate does not generate additional waste species.

The accelerant can be added when preparing said mixture (1). It can be included immediately in the basic solution or it can be added to the mixture of basic solution and U-based material. In a preferred embodiment of the method according to the invention, said at least one accelerant is added in a predetermined amount to said mixture, at least 50% of said predetermined amount, preferably at least 60% thereof, more preferably at least 70% thereof and most preferably at least 80% thereof being added to said mixture (1) after said basic solution has reacted for at least 30 minutes, preferably for at least 60 minutes, with said U-based material. Preferably, the accelerant is substantially entirely added to the mixture of basic solution and U-based material after the basic solution has reacted for at least 30 minutes, preferably for at least 60 minutes, with the U-based material. More preferably, addition of the accelerant is started after the reaction between the basic solution and the U-based material is substantially finished.

By first allowing the U-based material to react with the basic solution before adding the accelerant thereto, no or less accelerant is wasted for oxidizing compounds or phases which can be oxidized at least partially by means of the basic solution. When embedded in an aluminum containing matrix, this matrix can be oxidized substantially completely with the basic solution. Also part of the U-Me alloy can be oxidized at least partially. The present inventors have found in particular that for example a UMn₂ phase can be oxidized by means of the basic solution when it contains the oxidant (mineral salt) which is capable of reacting with hydrogen in the basic solution, in particular NaNO₃. In general, U-Me phases containing more Me than the U₆Me phase, such as UMn₂, UFe₂, UCo and U₇Ni₉ are considerably easier to oxidize than the corresponding U₆Me phase. Aluminum metal is oxidized completely to Al(III) but the uranium contained in the U-Me alloy is only partially oxidized to U(IV).

In a preferred embodiment of the method according to the invention, said at least one accelerant is added to said mixture (1) in the maximum amount of accelerant which can react with said U-based material in said mixture (1) or in an amount which is larger than said maximum amount or which is at least 80%, preferably at least 90% of said maximum amount, the amount of said at least one accelerant which is added to said mixture (1) being preferably comprised between 90 and 130% of said maximum amount, more preferably between 95 and 120% of said maximum amount. In this embodiment, the amount of accelerant is effective to convert a large fraction of the uranium to uranium (VI). In this way, a high yield of ⁹⁹Mo can be achieved. Preferably, the uranium contained in said mixture (1) is oxidized by means of said at least one accelerant until at least 70.0 wt. %, preferably until at least 80.0 wt. %, of the uranium contained in said mixture (1) is oxidized to uranium (VI). Most preferably, substantially all of the uranium contained in said mixture (1) is oxidized to U(VI).

Within the context of the present invention, the expression “in a maximum amount of accelerant which can react with said U-based material” is intended to denote the stoichiometric amount of accelerant required to react with said U-based material. It is therefore understood that when the maximum amount of accelerant is strictly lower than 100% of said maximum amount, the accelerant is in substoichiometric amount. Furthermore, when the maximum amount of accelerant is strictly higher than 100% of said maximum amount, it is understood that the accelerant is in an overstoichiometric amount.

The U-based material may consist essentially of said at least one U-Me alloy. A ²³⁵U target can be produced of the U-Me alloy which consists of one or more pieces of the U-Me alloy. In a preferred embodiment of the method according to the invention, the U-based material comprises said at least one U-Me alloy in a particulate form, i.e. in the form of particles or more particularly in the form of a powder.

The particulate U-Me alloy can be made by melting the U-Me alloy composition and casting it in the form of an ingot. The ingot can then be crushed and/or milled into particles. Subsequently the obtained particles can be separated, in particular sieved, into different particle size fractions.

The particulate U-Me alloy can be used to produce a ²³⁵U target. Such a ²³⁵U target may be plate-, rod- or tube-shaped. Preferably, the ²³⁵U target is plate-shaped. The U-Me alloy particles are preferably mixed with a matrix metal powder, which is typically an aluminum metal or alloy powder. A consolidated plate can be made of the mixture of both powders by a powder metallurgy process, in particular by exerting a pressure on the mixture, for example by extrusion or preferably by cold and/or hot rolling. The mixture of both powders is preferably applied in a frame and is subsequently enclosed in a casing by cladding it on both sides with a metal sheet. Both the frame and the claddings are preferably made of aluminum. The rolling of the target is done with the frame and the claddings applied around the powder mixture. By the hot or cold rolling process, the porosity of the mixture is reduced and the particles are consolidated to form one solid plate which is suitable as target for being irradiated, in particular with neutrons.

In a preferred embodiment of the present invention, the particle volume fraction of the matrix in said at least one U-based material is at least 30.0%, preferably at least 40.0%, more preferably at least 45.0% relative to the total particle volume of the U-based material. It is further understood that the particle volume fraction of the matrix in said at least one U-based materials is preferably equal to or less than 90.0%, more preferably less than 75.0%, even more preferably less than 60.0% relative to the total particle volume fraction of the U-based material.

As explained hereabove, in step 2 of the process the matrix material, the frame and the cladding can be dissolved/digested by means of the basic solution, even if this basic solution doesn't contain an oxidant. An oxidant, such as in particular a nitrate salt (f.e. NaNO₃) is however preferably provided in the mixture of basic solution and U-Me alloy to reduce or prevent the production of hydrogen gas. When the matrix material, the frame and the cladding are dissolved/digested, the U-Me alloy particles may remain in the mixture (1) when they are not yet oxidized by means of the accelerant.

The wording “dissolved” is used in the present specification does not mean that the material has to be actually brought into solution in the mixture but it only indicates that the material is converted into its oxidized form, in particular in the form of an AlO₂ salt (f.e. NaAlO₂) which may precipitate in the mixture so that the original matrix, frame and/or cladding material has disappeared. The term “dissolved” is thus used as an alternative term for “digested”.

The particulate U-Me alloy present in the mixture (1) has in certain embodiments a D₉₀ value, measured in accordance with ASTM B214-16, which is smaller than 120 μm, preferably smaller than 110 μm, more preferably smaller than 100 μm. The U-Me alloy is thus present in said mixture (1) the form of a powder.

In a first preferred embodiment of the method according to the present invention this powder is dispersed in the basic solution and the obtained mixture (1) is subjected to ultrasonic waves during at least part of the oxidation step 3. The present inventors have indeed found that especially the U₆Me phase in the alloy is only superficially oxidized by means of the accelerant and larger particles can be digested by removing the outer oxidation layers by sonication. Digestion and sonication is preferably continued until at least 70.0 wt. %, preferably until at least 80.0 wt. %, of the uranium contained in said mixture (1) is oxidized to uranium (VI).

In a second preferred embodiment, said particulate U-Me alloy has a D₉₀ value, measured in accordance with ASTM B214-16, which is smaller than 50 μm, preferably smaller than 40 μm, more preferably smaller than 30 μm and most preferably smaller than 25 μm. Particles having such a small size can be digested more completely than larger particles without sonication. However, sonication can additionally be applied to enhance the oxidation process. Preferably, the particulate U-Me alloy has a D₁₀ value, measured in accordance with ASTM B214-16, which is larger than 1 μm, preferably larger than 2 μm, more preferably larger than 3 μm and most preferably larger than 4 μm.

Both in the first and the second preferred embodiment, the at least one U-Me alloy comprising preferably at least 80.0 wt. %, more preferably at least 90.0 wt. %, or at least 95.0 wt. % or even at least 98.0 wt. % of said U₆Me phase. In this way, quite high U densities can be achieved.

In a further preferred embodiment the at least one U-Me alloy comprises two phases of an eutectic system, a first of said phases being said U₆Me phase, and a second of said phases being a phase with a lower uranium density [lower U density phase, herein after].

The term “eutectic system” is used to indicate a mixture of two substances that melts or solidifies at a single temperature that is lower than the melting point of either of the constituents. The eutectic system has an eutectic point for a particular composition of the two substances at which the melting temperature of the mixture is the lowest and at which an eutectic microstructure can be achieved, which comprises in particular a lamellar structure. The eutectic system is in particular selected from the consisting of U₆Mn/UMn₂, U₆Fe/UFe₂, U₆Co/UCo and U₆Ni/U₇Ni₉.

The U-Me alloy may have a composition corresponding to the eutectic composition itself. For the U—Mn alloy this corresponds to about 5.9 wt. % Mn/94.1 wt. % U, for the U—Fe alloy this corresponds to about 10.8 wt. % Fe/89.2 wt. % U, for the U—Co alloy this corresponds to about 11.5 wt. % Co/88.5 wt. % U and for the U—Ni alloy this corresponds to about 10.8 wt. % Ni/89.2 wt. % U. However, lower or higher concentrations of Me are possible in particular within the concentration limits wherein the above described eutectic system occurs.

For the U₆Mn/UMn₂ eutectic system the amount of Mn may range between 3.7 and 31.5 wt. % of Mn in the U—Mn alloy. For the U₆Fe/UFe₂ eutectic system the amount of Fe may range between 3.8 and 31.9 wt. % of Fe in the U—Fe alloy. For the U₆Co/UCo eutectic system the amount of Co may range between 4.0 and 19.8 wt. % of Co in the U—Co alloy. For the U₆Ni/U₇Ni₉ eutectic system the amount of Ni may range between 3.9 and 24.1 wt. % of Ni in the U—Ni alloy. Within these ranges, the U-Me alloy thus comprises the two phases of the eutectic system.

The lower limits (LL) are calculated based on the percent by weight of Me in U₆Me. At these lower limits, the U-Me alloy when in equilibrium thus comprises substantially 100% of the U₆Me phase. The upper limits (UL) are calculated based on the percent by weight of Me in the other phase of the eutectic system, namely in UMn₂, UFe₂, UCo and U₇Ni₉. At these upper limits (UL) the U-Me alloy when in equilibrium thus comprises substantially 100% of the lower U density phase. In between, the relative amounts of the two phases, in percent by weight, can be determined by means of the Lever rule. This Lever rule is based on a linear relationship between the amount (in percent by weight) of the two phases (respectively wt. % U₆Me and wt. % lower U density phase) between the minimum (0 wt. %) and the maximum percentage (100 wt. %) of both phases when in equilibrium in function of the weight percent of the Me element in the alloy composition (wt. % Me), resulting in the following formulae:

Wt.% U₆Me=100*(UL−wt. % Me)/(UL−LL); and

Wt % lower U density phase=100*(wt. % Me−LL)/(UL−LL).

The relative amounts of U and Me in the composition of the alloy can thus be determined in advance based on the relative amount of the two phases that are to be achieved in the solidified alloy. In the solidified alloy, the relative amount of the two phases can be determined by imaging techniques. In particular the volume % of each of the two phases can directly be determined on the basis of the image, which can then be converted to weight % based on the densities of each of the two phases.

In a preferred embodiment of the method of the invention, the at least one U-Me alloy comprising at least 5.0 wt. %, preferably at least 10.0 wt. %, more preferably at least 15.0 wt. % and most preferably at least 20.0 wt. % of said lower U density phase. It was indeed found that the lower U density phase is easier to digest than the U₆Me phase. When the lower U density phase is digested, the basic solution and the accelerant can penetrate within the U-Me alloy particles and can also digest the U₆Me phase. This phase is contained in grains (i.e. in U₆Me crystals) which are small so that they can be digested completely or at least more completely than the larger grains. When the U-Me alloy comprises an eutectic microstructure, the two phases are contained in this microstructure in alternating layers or lamellae. These have only a very limited thickness so that they can easily be digested completely.

The microstructure of the U-Me alloy, in particular the grain size, may depend on the solidification process. Smaller grain sizes can for example be obtained by a faster solidification process.

In certain embodiments, the at least one U-Me alloy comprising at least 40.0 wt. %, preferably at least 50.0 wt. %, more preferably at least 60.0 wt. % and most preferably at least 70.0 wt. % of said U₆Me phase. Such amount of U₆Me phase provide a relatively high U density but still enable to have the above described amounts of the lower U density phase in the alloy.

### EXAMPLES

The invention will now be described in more details with reference to the following examples, whose purpose is merely illustrative and not intended to limit the scope of the invention. In the examples reference is made to the drawings wherein:

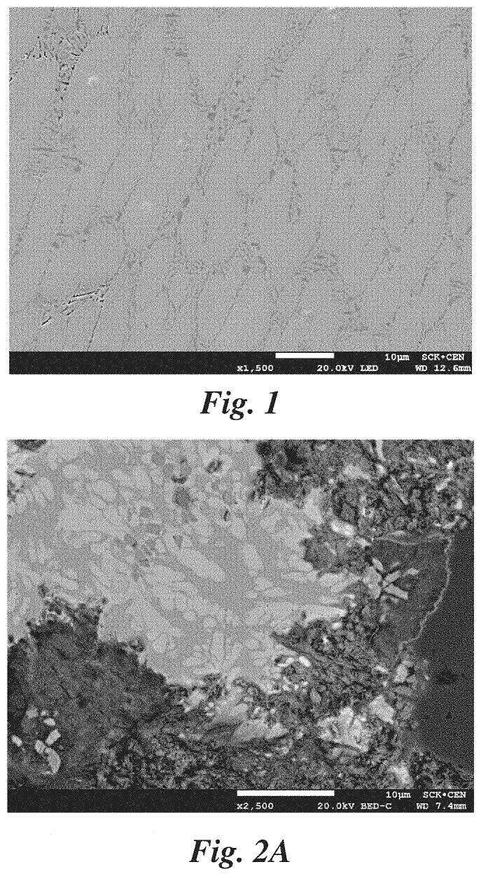

FIG. 1 is an SEM image of the U₆Mn alloy (U—Mn alloy 1);

FIG. 2A is an SEM image of a partially digested U₆Mn—UMn₂ 76/24 alloy (U—Mn alloy 2);

FIG. 2B is a part of the SEM image of FIG. 2A with a larger magnification;

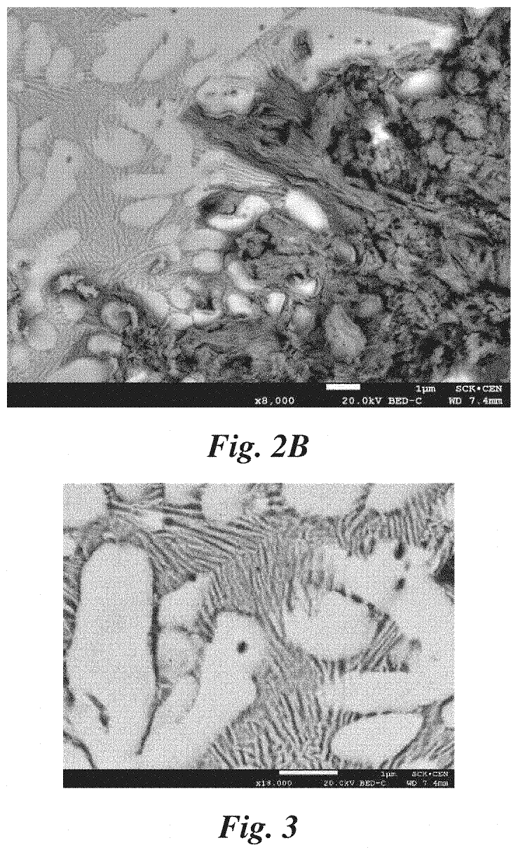

FIG. 3 is an SEM image of the U₆Mn—UMn₂ 88/12 alloy (U—Mn alloy 3);

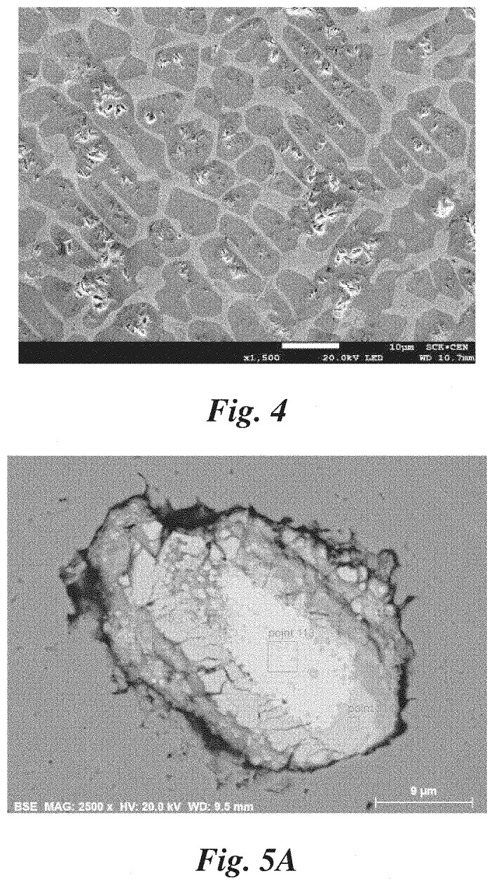

FIG. 4 is an SEM image of the U₆Mn—UMn₂ 41/59 alloy (U—Mn alloy 4);

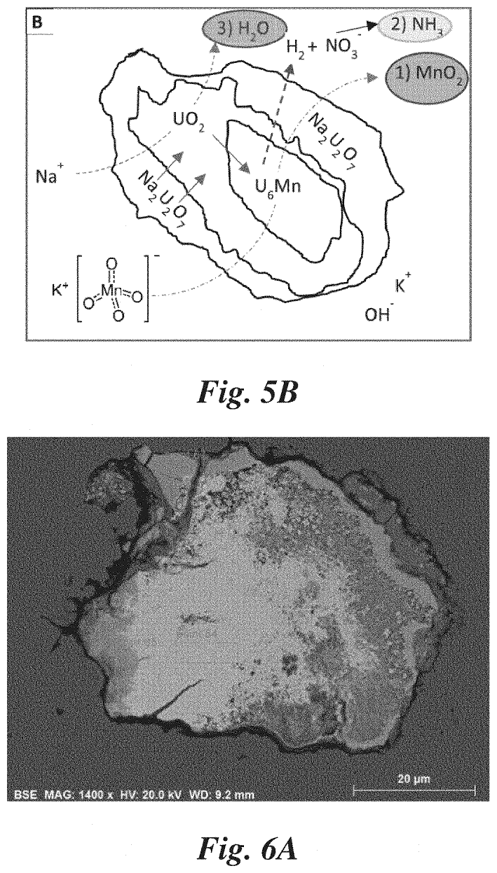

FIG. 5A is an SEM image of a partially digested U₆Mn alloy particle;

FIG. 5B is a schematic drawing of the SEM image of FIG. 5A onto which the different phases/digestion products are indicated;

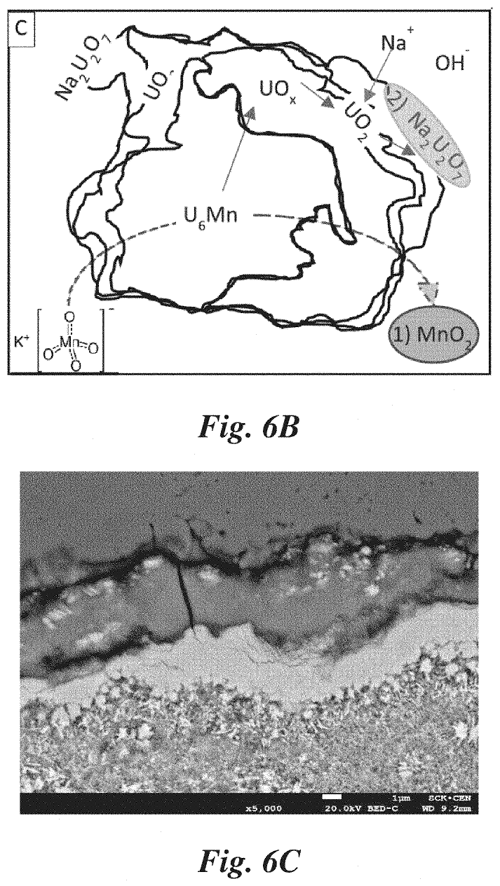

FIG. 6A is an SEM image of another partially digested U₆Mn alloy particle showing the presence of an intermediate UOₓ layer in between the U₆Mn core and the UO₂ layer;

FIG. 6B is a schematic drawing of the SEM image of FIG. 6A onto which the different phases/digestion products are indicated;

FIG. 6C is a part of the SEM image of FIG. 6A with a larger magnification; and

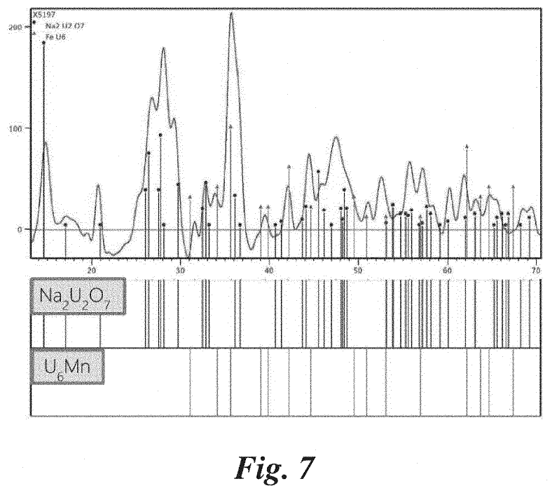

FIG. 7 is an XRD diffractogram from 15° to 70° of the particles of the target digested as described in Example 5.

### GENERAL PROCEDURE—PREPARATION OF U—Mn ALLOYS

All U—Mn alloys were made by arc-melting in an Arc 200 cold crucible arc-melting furnace under pure argon gas. Before melting, both metals (natural uranium and 99% Mn) were stripped of their surface oxide layer. The surface oxidation layer on the uranium was removed with 60% by volume nitric acid and wiped with acetone while manganese oxide on the manganese chips were sanded with silicon carbide paper and rinsed in acetone. For safety reasons, use was made of natural uranium but it is clear that in practice use will be made of uranium enriched in ²³⁵U and the material will be irradiated to fission part of the ²³⁵U to produce ⁹⁹Mo. A determined amount of metal uranium and metal manganese was loaded into the copper hearth, the furnace chamber was put under a vacuum of 4×10⁻³ mbar, backfilled with argon, then vacuumed a second time to 2.3×10⁻⁴ mbar for 1 h to ensure that as little oxygen is present in the chamber while arc-melting. To ensure homogeneity, each alloy is flipped and melted three times.

### U—Mn Alloy 1: Preparation of U₆Mn

U₆Mn was prepared according to the general procedure described above and was subsequently annealed to achieve its equilibrium structure. The production of U₆Mn is almost always accompanied with UMn₂ along its grain boundaries (see FIG. 1) in the form of an eutectic decomposition. The U—Mn alloy contained about 3.7 wt. % of Mn and 96.3 wt. % of U.

U—Mn Alloy 2: Preparation of U₆Mn—UMn₂ 76/24

U₆Mn—UMn₂ 76/24 was prepared according to the general procedure described above and was subsequently annealed to achieve its equilibrium structure. An SEM image of a partly digested particle of the produced alloy showed that it contained 76 wt. % of U₆Mn and 24 wt. % of UMn₂. Calculated with the Lever rule, such a mixture of phases contains about 10.4 wt. % of Mn. FIG. 2A shows an SEM image of the obtained alloy after partial digestion thereof as described here after. The outer darker part is digested the lighter core part is not yet digested. The undigested alloy comprises light U₆Mn grains in a darker eutectic U₆Mn—UMn₂ composition. FIG. 2B shows with a larger magnification the transition between the digested and the undigested part of the alloy. It can be seen that the matrix between the lighter U₆Mn grains is formed by an eutectic structure consisting of a succession of lighter U₆Mn and darker UMn₂ lamellae.

U—Mn Alloy 3: Preparation of U₆Mn—UMn₂ 88/12

U₆Mn—UMn₂ 88/12, containing 7 wt. % of Mn, was prepared in the same way as U—Mn alloy 2. FIG. 3 shows an SEM image of the obtained alloy. The alloy comprises light U₆Mn grains and an eutectic microstructure consisting of a succession of light U₆Mn and dark UMn₂ lamellae.

U—Mn Alloy 4: Preparation of U₆Mn—UMn₂ 41/59

U₆Mn—UMn₂ 41/59, containing 20 wt. % of Mn, was prepared in the same way as U—Mn alloys 2 and 3. FIG. 4 shows an SEM image of the obtained alloy. The alloy comprises dark UMn₂ grains in a light U₆Mn matrix.

### Comparative Example 1: Digestion of U₆Mn Alloy in NaOH/NaNO₃

In double-neck borosilicate reaction vessel equipped with a condenser, a 100 mL solution of 4M NaOH and 3M NaNO₃ was prepared and heated to 95° C. Powered 2.3 g of U—Mn alloy 1 was immersed into the solution and magnetically stirred. At designated time points, a 2 mL aliquot was immersed into a −4° C. bath and diluted to 1.2 M NaOH. The aliquot was then put under dialysis to eliminate salts and to isolate the digested particles.

The resulting digested particles were analyzed by SEM and EDX following the general procedure.

After 5 minutes of digestion and also after 30 minutes of digestion, SEM images and EDX mapping reveals that the UMn₂ located on the particle surface is oxidized to UO₂. The oxidation layer can penetrate deep into the particle but primarily along the grain boundary network of UMn₂. It is further observed that the U₆Mn is not oxidized, even in areas where U₆Mn is at the surface of the particles.

After 120 minutes of digestion, digestion was still substantially the same as after 30 minutes. The dispersion was filtered and a small elongated particle having a width of about 15 μm and a larger elongated particle having a width of about 45 μm were analyzed by SEM. The small particle predominantly consisted of UO₂ whilst the larger particle contained a mixture of UO₂ and U₆Mn. X-ray diffraction indicated that UO₂ was the only digestion product and that no sodium diuranate has formed in levels that are detectable by XRD. Additionally, U₆Mn still remains even after 120 minutes of digestion.

### Example 1: Digestion of U₆Mn Alloy in NaOH/NaNO₃ with Accelerant

In a double-neck borosilicate reaction vessel equipped with a condenser, a 200 mL solution of 4.3 M NaOH and 3.5 M NaNO₃ was prepared and heated externally to 60° C.

Powered 0.57 g of annealed U—Mn alloy 1 was immersed into the solution and magnetically stirred. 0.71 g of KMnO₄ was then immediately added with continued stirring. The experimental time was two hours. A 2 mL aliquot was then immersed into a −4° C. bath and diluted to 1.2 M NaOH. The aliquot was then put under dialysis to eliminate salts and to isolate the digested particles.

Cross section were analyzed (FIG. 5A). As the contrast in a BSE image depends on the density of the material, the particle can be seen with three different densities. At the core of the particle, the initial fuel can be seen that has partially digested. EDX analysis of this area shows that the average atomic percentage of this area is: Uranium 59±3%, Manganese 21±1%, and Oxygen 18±1%, which corresponds to undigested U₆Mn.

The second lightest region, located immediately outside the core, is found to have the atomic percentages: Oxygen 61.5±2%, Uranium 36±3%, with less than 1% manganese and sodium, and is ascribed to UO₂ resulting from the digestion of U—Mn alloy.

Finally the darkest part of the particle, at the particle edge has the atomic composition: Oxygen 66±2%, Uranium 14±3%, sodium 13±2%. This region is ascribed to a sodium diuranate region (Na₂U₂O₇ or NADU), which is the preferred form of yellow cake and ensures a maximum recovery of ⁹⁹Mo and other medical radioisotopes.

FIG. 5B is a schematic drawing of the SEM image of FIG. 5A onto which the different phases and reactions are indicated. The use of the accelerant enables to produce not only UO₂ as digestion product but also the required diuranate. Notwithstanding the digestion period of two hours, the sodium diuranate was however only produced at the surface of the particle, whilst the core of the particle even still contained the undigested U₆Mn. The development of the sodium diuranate layer apparently slows down and/or stops the further digestion of the particles once it reaches a few micrometer in thickness.

In some particles, the development of the UO₂ layer has been found. BSE images of some partially digested particles have shown that apart from the U₆Mn core and the UO₂ and Na₂U₂O₇ regions there is an UOₓ intermediate region in between the U₆Mn core and the UO₂ region. FIG. 6A is an SEM image of a particle which comprises, as indicated in FIG. 6B, a succession of a U₆Mn core, an intermediate UOₓ region, a UO₂ region and an outer Na₂U₂O₇ region. EDX analysis showed the intermediate UOₓ region had the atomic composition: Oxygen 55.7±2%, Uranium 27.4±3, Manganese 16.9±1%. FIG. 6C is a portion of FIG. 6A showing, with a larger magnification, the succession of the UOₓ region (lowermost speckled layer), the UO₂ layer (more uniform lighter layer) and the diuranate layer (outer more uniform darker layer). The presence of this intermediate UOₓ region might explain why the further digestion of the U₆Mn particles is halted after some time. The structure in the UOₓ region could possibly be a porous network of UO₂ containing leftover manganese from the U₆Mn phase and closing possibly in on itself to form a solid layer. The porous network would allow ions to pass through this area, facilitating digestion. Once the network closes ions are prevent from reaching the fresh fuel, and the digestion of the core is arrested. The NADU layer had a thickness of between about 3 μm and 5 μm. This example shows therefore that when the U₆Mn particles are sufficiently small, they can be digested completely.

### Example 2: Core Shell Separation of Digested U₆Mn Alloy Via Ultrasonication

Digested particles obtained in example 1 were placed in an ultrasonic bath, and were exposed to 40 kHz of ultrasonication for 15 minutes.

BSE images revealed that the core particles of U₆Mn were free of a shell layer, and were in other words no longer covered by a NADU and/or a UO₂ layer. EDX analysis of one of these particles showed that it had the following atomic composition: Uranium 82±3%, Mn 13±2%, with minor amounts of oxygen, corresponding to U₆Mn. Hence, when performing the ultrasonication during the digestion in the basis solution the digestion can proceed until all of the U₆Mn is digested. Some shell particles could also be detected. These shell particles consisted of NADU. Most of the UO₂ removed by sonication from the surface of the particles could thus be converted to the desired NADU.

Ultrasonication therefore effectively removes the shell composed of sodium diuranate and UO₂, hence favoring the digestion of the undigested U—Mn alloy core.

### Example 3: Digestion of a U₆Mn—UMn₂ 76/24 Alloy in a NaOH/NaNO₃ with Accelerant

The digestion of a U₆Mn, —UMn₂ 76/24 alloy was carried out in a same way as in Example 1.

The resulting digested particles were analyzed by SEM and EDX.

The BSE image of a digested U₆Mn—UMn₂ 74/24 alloy after digestion for only 15 minutes is shown in FIGS. 2A and 2B. As explained here above, the structure of the alloy consisted of U₆Mn grains embedded in an eutectic matrix formed by a microstructure formed by thin parallel lamellae of U₆Mn and UMn₂. Notwithstanding the very thin lamellae, the UMn₂ lamellae were quickly and easily digested by the basic solution containing the accelerant. The image in FIGS. 2A and 2B reveals indeed that the alloy has been digested or dealloyed after 15 minutes more than 10 μm past the particle surface. The UMn₂ phase dissolves more favorably than the U₆Mn phase. Islands of U₆Mn can be found in the zone between the corrosion front and within the alloy surface. The corrosion front advances along UMn₂ pathways, hence resulting in a percolating pathway for the digestion reagents to digest the remaining undigested U—Mn alloy.

### Example 4: Digestion of a U₆Mn—UMn₂ Alloy in a NaOH/NaNO₃ with Accelerant

In this example the U₆Mn—UMn₂ alloy is first digested in the basic solution without accelerant. It has indeed been shown in Comparative Example 1 that the UMn₂ phase can be oxidized by means of the basic solution to UO₂. After this initial digestion step, accelerant is added to oxidize the UO₂ phase further to the diuranate phase and to digest also the U₆Mn phase, and any remaining UMn₂ phase. In this example, less KMnO₄ is needed and consequently less MnO₂ and thus less waste is produced.

### Example 5: Digestion of U₆Mn Alloy Dispersed in an Aluminum Matrix/Fuel Target

A U₆Mn alloy was ground into a powder and was dispersed in an aluminum powder. The U—Mn alloy embedded in aluminum was further cladded in aluminum and was rolled to produce a target plate was cut into 4 cm by 1 cm pieces for the digestion experiments.

A solution of 4M NaOH and 3M NaNO₃ was prepared in a digestion vessel. The hot water bath containing the digestion vessel was heated to 40° C. before the start of the experiment. The target piece was inserted into the digestion vessel stirred with a magnetic stir bar. The aluminum cladding slowly reacted with the digestion solution releasing H₂ gas which reacted with the NaNO₃ to produce NH₃. After one hour, no gas was visibly produced any more from the aluminum cladding. The temperature of the hot water bath containing the digestion vessel increased during this first hour to about 50° C. and stirring continued for another 40 minutes, to help ensure no gas remained in solution and that the aluminum that was dispersed between the U—Mn alloy fuel had time to dissolve. After 110 minutes, when the reaction mixture reached a temperature of nearly 80° C., potassium permanganate was added to the reaction vessel as accelerant. The accelerant was immediately reduced to MnO₂. KMnO₄ was continually added until the accelerant was no longer reduced and kept its Mn^{VII} state.

After 150 minutes of digestion, the mixture had a temperature of about 90° C. and the obtained digested U-based material was filtered from the solution.

XRD diffractogram from 15° to 70° in 2θ, shown in FIG. 7, reveals mainly sodium diuranate but also a remaining amount of U₆Mn. In the same way as in Example 1, the cores of the alloy particles were still undigested and was composed of U₆Mn. The cores were surrounded by a layer of NADU. Based on Examples 1 and 2, it is clear that any remaining U₆Mn can thus be avoided by reducing the particle size of the U—Mn alloy in the target and/or by replacing the U₆Mn alloy by a U₆Mn—UMn₂ alloy containing an easily digestible UMn₂ phase which can expose the U₆Mn grains (optionally in the form of lamellae) so as to be also completely digestible.

1-19. (canceled)

20. A method for at least partially digesting a uranium-based material (U-based material, herein after) which comprises at least one uranium-metal alloy [U-Me alloy, herein after], wherein Me is selected from the group consisting of Mn, Fe, Co, Ni and combinations thereof and wherein the U-Me alloy comprises at least a U₆Me phase, which method comprises the following steps:
Step 1: providing the U-based material;
Step 2: contacting the U-based material with a basic solution thereby forming a mixture (1); and
Step 3: oxidizing at least part of said uranium in said mixture (1) to uranium (VI) by means of at least one accelerant selected from the group consisting of permanganate (MnO₄²⁻), chromate (CrO₄²⁻), dichromate (Cr₂O₇²⁻), perchlorate (ClO₄⁻), chlorate (CO₃⁻), chlorite (ClO₂⁻), ozone (O₃) and hypohalite (XO⁻).

21. The method according to claim 20, wherein said basic solution is a solution comprising one or more alkali or alkaline earth hydroxides.

22. The method according to claim 20, wherein said basic solution is a solution comprising one or more alkali or alkaline earth hydroxides being present in the basic solution in a concentration of at least 1.0 mol/L.

23. The method according to claim 20, wherein said basic solution comprises at least one mineral salt which is capable of reacting with hydrogen in said basic solution.

24. The method according to claim 20, wherein said basic solution comprises at least one nitrate salt which is capable of reacting with hydrogen in said basic solution, wherein said nitrate salt is present in the basic solution in a concentration of at least 1.0 mol/L.

25. The method according to claim 20, wherein said at least one accelerant is added to said mixture (1) in a maximum amount of accelerant which reacts with said U-based material in said mixture (1) or in an amount which is larger than said maximum amount or which is at least 80% of said maximum amount.

26. The method according to claim 20, wherein the uranium in said mixture (1) is oxidized by means of said at least one accelerant until at least 70.0 wt. % of the uranium contained in said mixture (1) is oxidized to uranium (VI).

27. The method according to claim 20, wherein said at least one accelerant is added in a predetermined amount to said mixture, at least 50.0% of said predetermined amount being added to said mixture (1) after said basic solution has reacted for at least 30 minutes with said U-based material.

28. The method according to claim 20, wherein said accelerant comprises permanganate.

29. The method according to claim 20, wherein said U-based material comprises said U-Me alloy in a particulate form.

30. The method according to claim 29, wherein said U-Me alloy is dispersed in an aluminum based matrix.

31. The method according to claim 29, wherein said particulate U-Me alloy has a D₉₀ value, measured in accordance with ASTM B214-16, which is smaller than 120 μm.

32. The method according to claim 29, wherein said U-Me alloy is dispersed in said basic solution, the mixture (1) being subjected to ultrasonic waves during at least part of said oxidation Step 3.

33. The method according to claim 20, wherein the at least one U-Me alloy comprises two phases of an eutectic system, a first of said phases being said U₆Me phase, and a second of said phases being a phase with a lower uranium density [lower U density phase, herein after], the at least one U-Me alloy comprising at least 5.0 wt. % of said lower U density phase.

34. The method according to claim 33, wherein the at least one U-Me alloy comprises at least 40.0 wt. % of said U₆Me phase.

35. The method according to claim 33 wherein said eutectic system is selected from the group consisting of U₆Mn/UMn₂, U₆Fe/UFe₂, U₆Co/UCo and U₆Ni/U₇Ni₉.

36. The method according to claim 20, wherein the at least one U-Me alloy comprising at least 80.0 wt. % of said U₆Me phase.

37. The method according to claim 20, wherein said U-Me alloy is a U—Mn alloy and said U₆Me phase is a U₆Mn phase.

38. The method according to claim 20, wherein said U-Me alloy comprises ²³⁵U, and the U-based material is irradiated by means of neutrons before being partially digested.

39. The method according to claim 20, wherein said U-Me alloy comprises less than 20 wt. % of ²³⁵U of the total amount of U, and the U-based material is irradiated by means of neutrons before being partially digested.
